(19) United States
(12) Patent Application Publication
(10) Pub. No.: US 2007/0245404 A1
(43) Pub. Date: Oct. 18, 2007

(54) INFORMATION PROCESSING APPARATUS, MANAGEMENT METHOD THEREFOR, COMPUTER-READABLE RECORDING MEDIUM RECORDING MANAGEMENT PROGRAM, INFORMATION PROCESSING SYSTEM

(75) Inventor: Kensuke OKANO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/548,718

(22) Filed: Oct. 12, 2006

(30) Foreign Application Priority Data
Mar. 28, 2006 (JP) 2006-089214

(51) Int. Cl. H04L 9/32

(52) U.S. Cl. 726/3

(57) ABSTRACT

The present invention relates to an information processing apparatus having a network device and connected through the network device to a network. The information processing apparatus comprises a stop processing unit for stopping a function of the network device on the basis of a disconnection instruction signal giving an instruction for disconnection from the network, and a setting unit for disabling the function of the network device on the basis of the disconnection instruction signal and further for setting a locked state, releasable only by a specified authority person, with respect to the network device. This can reliably prevent the spread of computer virus through the network.

### BACKGROUND OF THE INVENTION

1) Field of the Invention

The present invention relates to an information processing apparatus, management method therefore, computer-readable recording medium recording a management program and information processing system, suitable for use in prevention of spread of computer viruses through a network.

2) Description of the Related Art

So far, there have been known computer viruses or worms (which hereinafter will be referred to simply as “computer virus”) which effect data destruction, system destabilization, data leakage and others with respect to computers.

For example, a computer virus has a self-infection function to make its own copies for spreading the infection into other computers, which creates a problem in that, when this computer virus infects a computer connected to a network, other computers and servers on the same network are inflected with this computer virus so that the entire network system suffers serious damages.

In recent years, various types of systems and software have been developed in order to prevent the spread of a computer virus on a network and, for example, there have generally been known techniques for realizing a function to provide a recovery from an infected state in a processing terminal itself, a function to detect a computer virus through the use of a server for preventing the spread into the external, a function (firewall) to cut off ports, and other functions.

For example, the following Patent Document 1 discloses a technique for logically cutting off a connection with a network for a standalone (isolated) state during a virus check, thereby preventing the spread of a computer virus through the network during the virus check processing.

Moreover, the following Patent Document 2 discloses a technique for detecting an abnormal state of a device for cutting off a line in communication, and the following Patent Document 3 discloses a technique for disconnecting a computer from a network on the basis of a detection result notified from a virus isolating system of the computer. Still moreover, the following Patent Document 4 discloses a technique for reconnecting a network device with a disconnected network.

[Patent Document 1] Japanese Patent Laid-Open No. HEI 11-073384

[Patent Document 2] Japanese Patent Laid-Open No. 2001-339532

[Patent Document 3] Japanese Patent Laid-Open No. 2005-025679

[Patent Document 4] Japanese Patent Laid-Open No. 2002-198968

However, since the technique disclosed in the aforesaid Patent Document 1 is designed to logically cut off the connection with a network, in the case of, for example, the infection by a computer virus having a function to make a communication freely through self-made logical reconnection with a network, there is a possibility that a computer once disconnected from the network is reconnected logically through this computer virus to the network, which creates a problem in that, depending on the type of computer virus, difficulty is experienced in reliably preventing the spread of the computer virus through the network.

In addition, since the techniques disclosed in the aforesaid Patent Documents 2 to 4 are designed to cut off a connection between a computer and a network in response to detection of a computer virus, there is a possibility that, for example, after the disconnection from the network, the user makes a reconnection of the computer to the network for his/her own convenience without knowing the infection by the computer virus, which creates a problem in that difficulty is encountered in reliably preventing the spread of the computer virus.

### SUMMARY OF THE INVENTION

The prevent invention has been developed in consideration of these problems, and it is therefore an object of the invention to provide an information processing apparatus, management method therefor, computer-readable recording medium recording a management program and information processing system, capable of reliably preventing the spread of a computer virus through a network.

For this purpose, in accordance with the present invention, there is provided an information processing apparatus having a network device and connected through the network device to a network, comprising a stop processing unit stopping (suspending) a function of the network device on the basis of a disconnection instruction signal giving an instruction for disconnection from the network, and a setting unit disabling the function of the network device on the basis of the disconnection instruction signal and further setting a locked state, releasable only by a specified authority person, with respect to the network device.

Preferably, the stop processing unit stops the function of the network device by cutting off supply of power to the network device.

In addition, it is also appropriate that the stop processing unit stops the function of the network device by cutting off supply of a signal to the network device.

Still additionally, it is also appropriate that the stop processing unit stops the function of the network device by inputting a control signal to the network device.

Moreover, preferably, the information processing apparatus further comprises a display control unit displaying a setting screen on a display device for inputting identification information knowable by only the specified authority person so that the specified authority person inputs the identification information through the setting screen to make a release from the locked state set with respect to the network device.

Furthermore, in accordance with the present invention, there is provided a method of managing an information processing apparatus having a network device and connected through the network device to a network, comprising a stop processing step stopping a function of the network device on the basis of a disconnection instruction signal giving an instruction for disconnection from the network, and a setting step disabling the function of the network device on the basis of the disconnection instruction signal and further setting a locked state releasable only by a specified authority person.

Preferably, in the stop processing step, the function of the network device is stopped by cutting off supply of power to the network device.

In addition, it is also appropriate that, in the stop processing step, the function of the network device is stopped by cutting off supply of a signal to the network device.

Still additionally, it is also appropriate that, in the stop processing step, the function of the network device is stopped by inputting a control signal to the network device.

Moreover, preferably, the managing method further comprises a display control step displaying a setting screen on a display device for inputting identification information knowable by only the specified authority person so that the specified authority person inputs the identification information through the setting screen to make a release from the locked state set with respect to the network device.

Furthermore, in accordance with the present invention, there is provided a computer-readable recording medium recording a management program for making a computer carry out a management function to manage an information processing apparatus having a network device and connected through the network device to a network, the management program making the computer function as a stop processing unit stopping a function of the network device on the basis of a disconnection instruction signal giving an instruction for disconnection from the network, and a setting unit disabling the function of the network device on the basis of the disconnection instruction signal and further setting a locked state, releasable only by a specified authority person, with respect to the network device.

Preferably, when the management program makes the computer function as the stop processing unit, the management program makes the computer stop the function of the network device by cutting off supply of power to the network device.

In addition, it is also appropriate that, when the management program makes the computer function as the stop processing unit, the management program makes the computer stop the function of the network device by cutting off supply of a signal to the network device.

Still additionally, it is also appropriate that, when the management program makes the computer function as the stop processing unit, the management program makes the computer stop the function of the network device by inputting a control signal to the network device.

Moreover, preferably, the management program makes the computer function as a display control unit displaying a setting screen on a display device for inputting identification information knowable only by the specified authority person so that the specified authority person inputs the identification information through the setting screen to make a release from the locked state set with respect to the network device.

Furthermore, in accordance with the present invention, there is provided an information processing system having a network device and connected through the network device to a network, comprising a disconnection signal generating unit generating a disconnection instruction signal giving an instruction for disconnection from the network, a stop processing unit stopping a function of the network device on the basis of the disconnection instruction signal, and a setting unit disabling the function of the network device on the basis of the disconnection instruction signal and further for setting a locked state, releasable only by a specified authority person, with respect to the network device.

Preferably, the stop processing unit stops the function of the network device by cutting off supply of power to the network device.

In addition, preferably, the information processing system further comprises a display control unit displaying a setting screen for inputting identification information knowable only by the specified authority person so that the specified authority person inputs the identification information through the setting screen to make the release from the locked state set with respect to the network device.

Moreover, it is also appropriate that the disconnection signal generating unit generates the disconnection instruction signal when a computer virus is detected by arbitrary detection software.

Still moreover, it is also appropriate that the disconnection signal generating unit is made such that the specified authority person generates the disconnection instruction signal.

According to the present invention, since the function of the network device is stopped and disabled on the basis of the disconnection instruction signal so as to inhibit the reconnection to the network except for changing the setting of the network device, for example, even in the case of a computer virus having a function to make a communication freely through self-made reconnection with a network, difficulty is encountered in cancelling the disability of the network device, thereby preventing the computer virus from making the reconnection to the network.

In addition, since the network device disabled is set to a locked state releasable by only the specified authority person, even in a case in which general users having no specified authority try to make the reconnection to the network, a change of the setting of the network device becomes impossible.

Therefore, for example, unless the specified authority person completes the extermination/quarantine of the computer virus with respect to the apparatus infected and permits the reconnection to the network, the general user can not make the reconnection to the network, which enables the specified authority person to reliably seize the situation of connection to the network.

That is, it is possible to reliably cut off the connection with the network and further to reliably maintain the non-connected state with the network after the disconnection, thereby reliably preventing the spread of the computer virus through the network.

Still additionally, since the communication function with the network can completely be stopped by cutting off the supply of power to the network device, by cutting off the supply of a signal to the network device or by inputting a control signal to the network device, even in the case of the infection by a computer virus having a function to make a communication freely through self-made reconnection with the network, it is possible to more reliably prevent the spread of the computer virus through the network.

Yet additionally, since the locked state set with respect to the network device is released in a manner such that the specified authority person inputs the identification information through the setting screen, for example, a specified authority password such as Supervisor becomes necessary for the release from the locked state, which makes it impossible that a general user having no special authority freely makes a connection to the network, thereby lessening the burden on the specified authority person and reliably preventing the spread of the computer virus through the network.

### BRIEF DESCRIPTION OF THE DRAWINGS

FIG. 1 is a block diagram showing a hardware configuration of an information processing system according to a first embodiment of the present invention;

FIG. 2 is an illustration useful for explaining the processing for stopping a function of a device by a stop processing unit of the information processing system according to the first embodiment of the present invention;

FIG. 3 is an illustration useful for explaining the processing for disabling a function of a device by a BIOS setting unit of the information processing system according to the first embodiment of the present invention;

FIG. 4 is an illustration of an example of a BIOS setting screen in a case in which a locked state is set by the BIOS setting unit of the information processing system according to the first embodiment of the present invention;

FIG. 5 is an illustration of an example of a BIOS setting screen in a case in which identification information is inputted through a display control unit of the information processing system according to the first embodiment of the present invention;

FIG. 6 is a flow chart showing an operation procedure for disconnecting, from a network, a processing terminal infected with a computer virus in the information processing system according to the first embodiment of the present invention;

FIG. 7 is a flow chart showing an operation procedure for making a reconnection of a processing terminal, disconnected from a network, to the network in the information processing system according to the first embodiment of the present invention;

FIG. 8 is an illustration useful for explaining the processing for stopping a function of a device by a stop processing unit in an information processing system according to a first modification of the first embodiment of the present invention;

FIG. 9 is an illustration useful for explaining the processing for disabling a function of a device by a BIOS setting unit in the information processing system according to the first modification of the first embodiment of the present invention;

FIG. 10 is an illustration useful for explaining the processing for stopping a function of a device by a stop processing unit in an information processing system according to a second modification of the first embodiment of the present invention;

FIG. 11 is an illustration useful for explaining the processing for disabling a function of a device by a BIOS setting unit in the information processing system according to the second modification of the first embodiment of the present invention;

FIG. 12 is an illustration useful for explaining the processing for stopping a function of a device by a stop processing unit in an information processing system according to a third modification of the first embodiment of the present invention;

FIG. 13 is an illustration useful for explaining the processing for disabling a function of a device by a BIOS setting unit in the information processing system according to the third modification of the first embodiment of the present invention;

FIG. 14 is a block diagram showing a hardware configuration of an information processing apparatus according to a second embodiment of the present invention; and

FIG. 15 is an illustration useful for explaining the processing for stopping a function of a device by a stop processing unit in an information processing system according to the second embodiment of the present invention.

### DESCRIPTION OF THE PREFERRED EMBODIMENTS

Embodiments of the present invention will be described hereinbelow with reference to the drawings.

### [1] Description of First Embodiment of the Present Invention

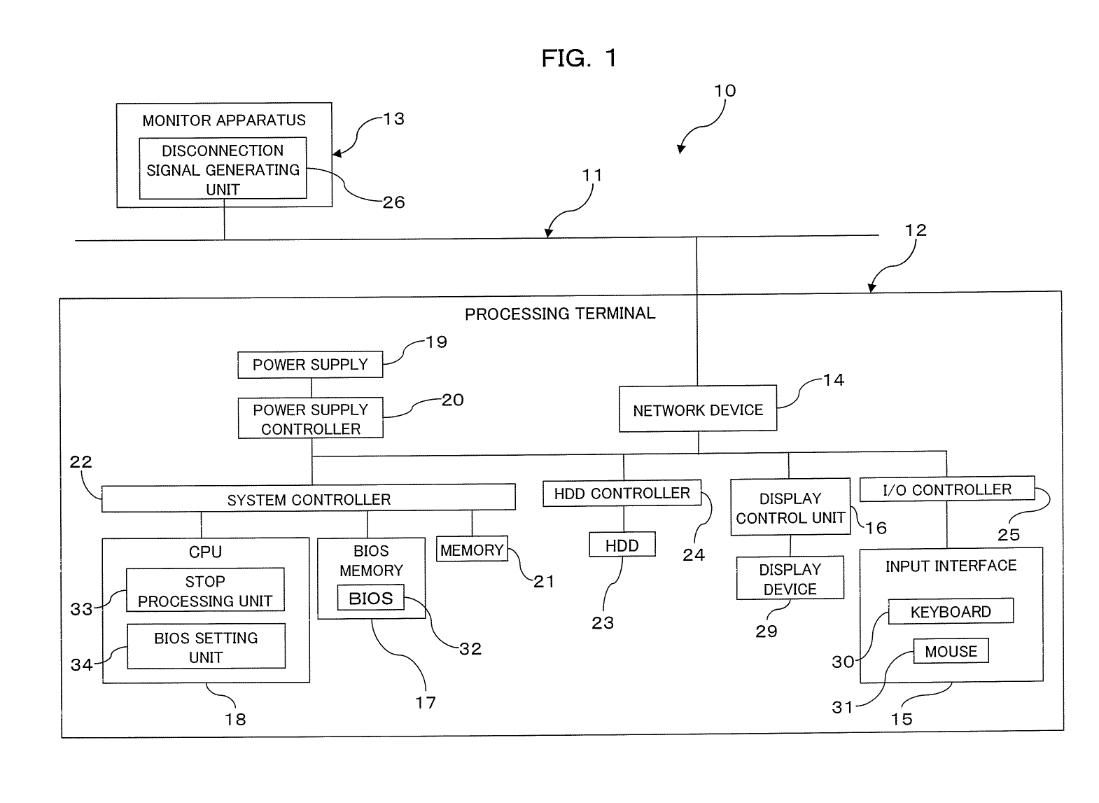

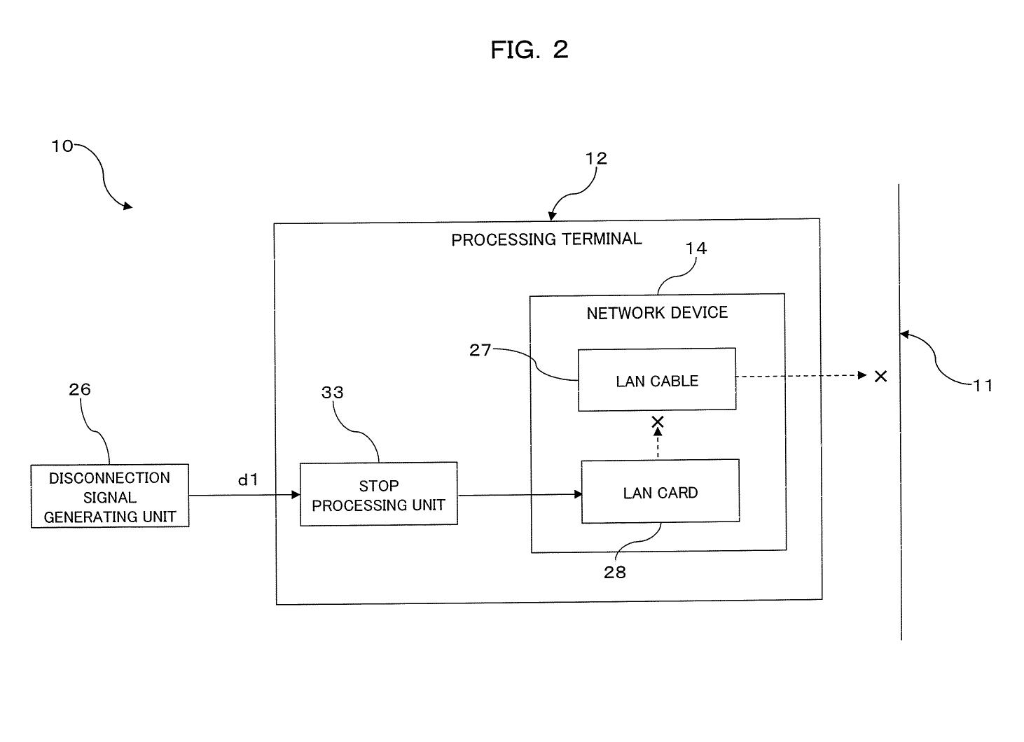

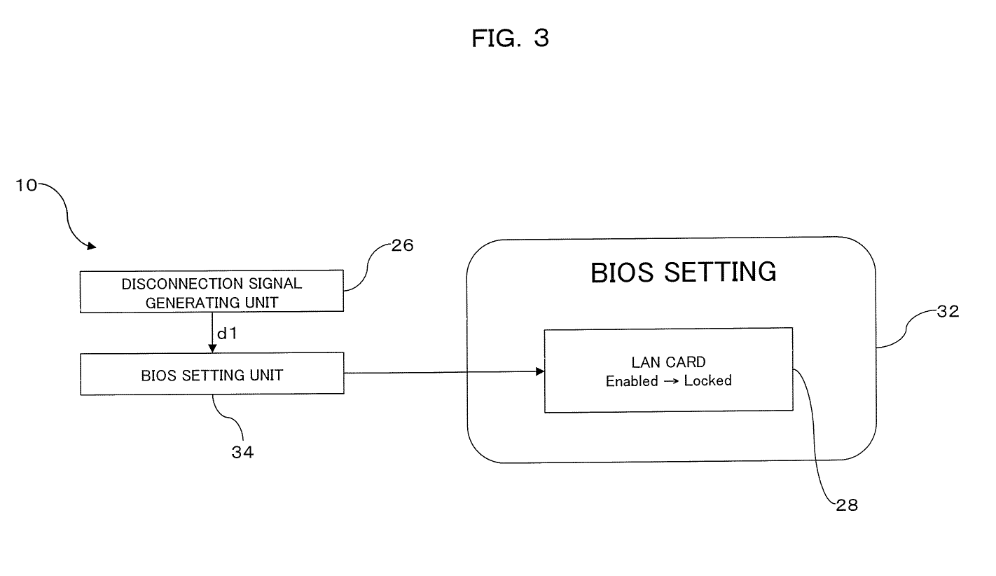

FIG. 1 is a block diagram showing a hardware configuration of an information processing system according to a first embodiment of the present invention, FIG. 2 is an illustration useful for explaining the processing for stopping a function of a device by a stop processing unit thereof, and FIG. 3 is an illustration useful for explaining the processing for disabling a function of a device by a BIOS setting unit thereof.

As shown in FIG. 1, an information processing system 10 according to this embodiment is made up of a processing terminal (information processing apparatus, computer) 12 connected to a network 11 and a monitor apparatus 13 connected through the network 11 to the processing terminal 12.

As shown in FIG. 1, the processing terminal 12 is constructed as a computer including a network device 14, an input interface 15, a display device 29, a display control unit 16, a BIOS (Basic Input Output System) memory 17, a CPU (Central Processing Unit) 18, a power supply 19, a power supply controller 20, a memory 21, a system controller 22, an HDD (Hard Disk Drive) 23, an HDD controller 24 and an I/O (Input/Output) controller 25.

The monitor apparatus 13 is for monitoring the processing terminal 12 and is constructed as a computer functioning as a disconnection signal generating unit 26. For example, the disconnection signal generating unit 26 is made to be capable of detecting the fact that the processing terminal 12 is infected with computer viruses or worms (which will hereinafter be referred to simply as computer virus).

Moreover, as shown in FIGS. 1 to 3, the monitor apparatus 13 includes the disconnection signal generating unit 26 for, when detecting that the processing terminal 12 is infected with computer virus, generating a disconnection instruction signal (disconnection signal) d1 giving an instruction to the processing terminal 12 for the disconnection of the processing terminal 12 from the network 11.

This disconnection signal generating unit 26 is realized in a manner such that a CPU of the monitor apparatus 13 executes, for example, computer virus detection software, and scans the processing terminal 12 connected to the network 11 to detect computer virus and, when detecting the computer virus, outputs the disconnection instruction signal d1.

In the monitor apparatus 13, the disconnection instruction signal d1 can be automatically generated and outputted in response to the detection of the computer virus by virus detection software, or in the monitor apparatus 13, it can also be arbitrarily generated and outputted according to an operation by a specified authority person such as a network supervisor.

In addition, as shown in FIGS. 2 and 3, the disconnection instruction signal d1 generated by the disconnection signal generating unit 26 is transmitted to a stop processing unit 33 and a BIOS setting unit (setting unit) 34 which will be mentioned later.

The network device 14 is made to connect the processing terminal 12 communicably to the network 11 and, for example, as shown in FIG. 2, is composed of a LAN (Local Area Network) cable 27 and a LAN card 28.

The LAN cable 27 is a cable for making a connection between the network 11 and the processing terminal 12, and the LAN card 28 is the device for carrying out the transmission/reception of data between the network 11 and the processing terminal 12.

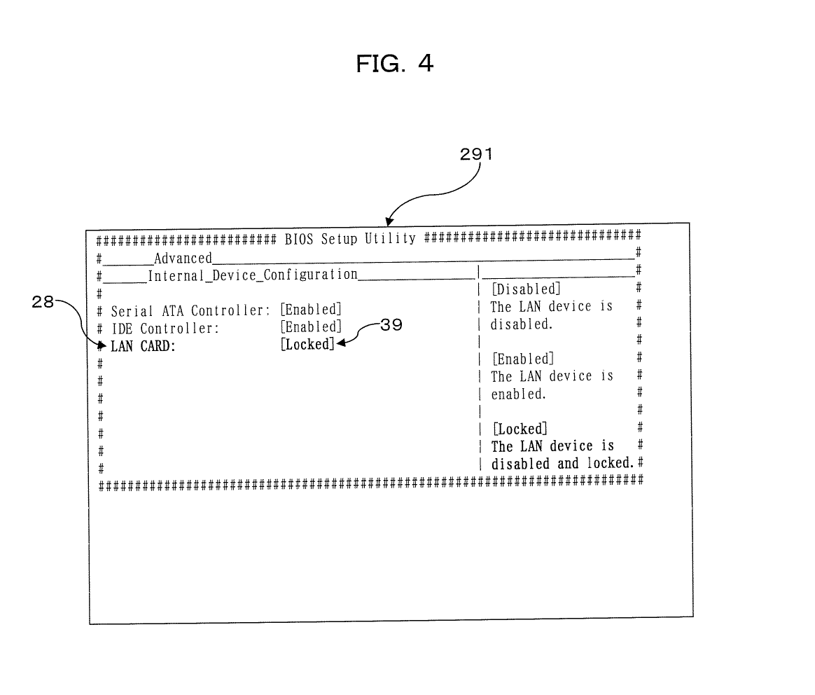

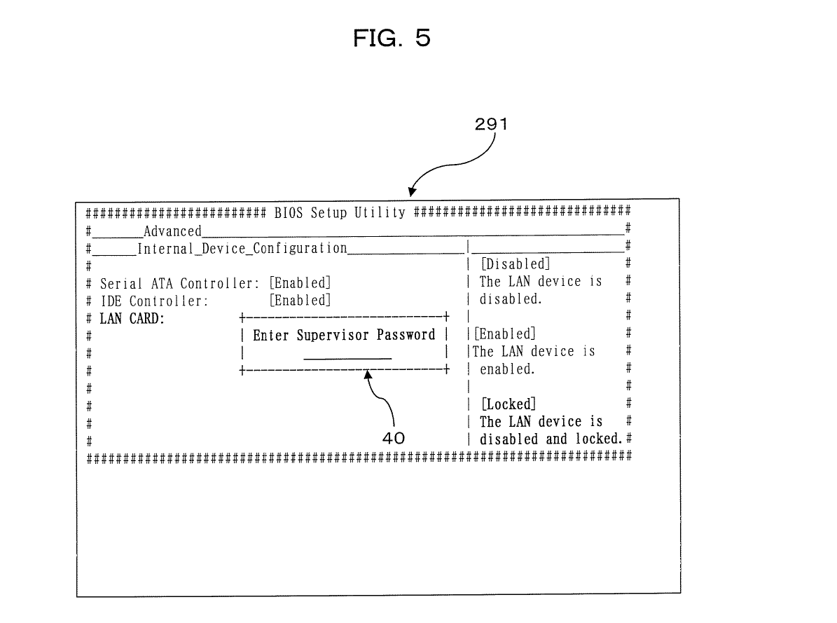

The display device 29 is for displaying various information related to the processing terminal 12 and, for example, displays a BIOS setting screen (setting screen) 291 (see FIGS. 4 and 5), mentioned later, and others. Moreover, the display control unit 16 is for controlling the display device 29.

The input interface 15 is for inputting data, instruction contents and others to the processing unit 12 through various inputs and operations by a user and, for example, includes a keyboard 30 and a mouse 31. The I/O controller 25 is for controlling the input interface 15.

Moreover, for example, the user inputs predetermined information through the keyboard 30 or the mouse 31 while making reference to the BIOS setting screen displayed on the display device 29, thus carrying out the above-mentioned various setting and others. This predetermined information signifies device setting (enabling, disabling, and others) or identification information (password or the like) as shown in FIGS. 4 and 5.

The BIOS memory 17 is a storage unit storing a BIOS 32 and, with respect to various types of devices (for example, the network device 14) or the like mounted in the processing terminal 12, this BIOS 32 carries out the initializations or sets the functions thereof or a power supply into an enabled state (enabled) or disabled state (disabled).

FIG. 4 is an illustration of an example of a BIOS setting screen in a case in which a locked state is set by a BIOS setting unit of the information processing system according to the first embodiment of the present invention, and FIG. 5 is an illustration of an example of a BIOS setting screen in a case in which identification information is inputted through a display control unit thereof.

In this embodiment, the BIOS 32 can be made to set ON/OFF of a power supply to the LAN card 28, and these setting in the BIOS 32 cannot be changed by the OS (Operating System).

The CPU 18 carries out various kinds of numerical calculations, information processing, device control and others in the processing terminal 12 and, as shown in FIG. 1, it functions as the stop processing unit 33 and the BIOS setting unit 34.

The stop processing unit 33 is for stopping (suspending) the function of the network device 14 on the basis of a disconnection instruction signal d1 generated by the disconnection signal generating unit 26 and, as shown in FIG. 2, it is made to stop the function of the network device 14 when receiving the disconnection instruction signal d1 transmitted from the disconnection signal generating unit 26 through the LAN cable 27 and the LAN card 28.

Concretely, in this embodiment, the stop processing unit 33 stops the function of the network device 14 by cutting of the power supply to the LAN card 28.

The BIOS setting unit 34 is made to selectively set the function of the network device 14 to one of an enabled state (Enabled), a disabled state (Disabled) and a locked state (locked) through the BIOS 32 and, in this first embodiment, as shown in FIG. 3, upon receipt of the disconnection instruction signal d1 transmitted from the disconnection signal generating unit 26, the function of the network device 14 is set to the locked state (Locked).

This locked state (Locked) is a kind of disabled state (Disabled) in which the function of the network device 14 is disabled as well as the disabled state (disabled) and only a specified authority person can make a release (enabling) from the disabled state (Disabled) into an enabled state (enabled).

Concretely, there is a need to input a password for the release from the locked state (Locked), and this password is knowable by only the specified authority person.

For example, the password (identification information) is set by a manufacturer or the like at the factory shipment and preserved in the BIOS memory 32 or in the HDD 23, and a paper sheet on which this password is written, together with the product, is put into a package and shipped, whereupon only the specified authority person (for example, network supervisor, system supervisor or the like) can know the password by managing this paper sheet. It is also appropriate that this password is arbitrarily changed by the specified authority person after purchase.

In this connection, in the BIOS 32, the LAN card 28 can be set to one of the enabled state (Enabled), the disabled state (Disabled) and the locked state (Locked).

In addition, when the LAN card 28 is set to the locked state (Locked), as shown in FIG. 4, “Locked” is displayed as a setting item 39 with respect to the LAN card 28.

The release (enabling) from the locked state (Locked) is made in a manner such that the identification information (password) only the specified authority person can know is inputted on the BIOS setting screen 291.

Concretely, when an operator selects the setting item 39 set as “Locked” on the BIOS setting screen 291 (display device 29) shown in FIG. 4, an identification information inputting screen 40 is displayed in a state overlapped with the BIOS setting screen 291 as shown in FIG. 5. The identification information inputting screen 40 indicates a message of “Enter Supervisor Password” which makes a request to the specified authority person for inputting a password.

In a case in which the specified authority person inputs the password through the identification information inputting screen 40 and a decision is made such that the password inputted through the identification information inputting screen 40 agrees with a password (identification information) registered in advance, there occurs the release (enabling) from the locked state (Locked) and the change from “Locked”to “Enabled”.

The power supply 19 is for supplying power to the processing terminal 12 and is, for example, an outlet, a battery or the like.

The power supply controller 20 is for controlling the power of the power supply 19 and is made to manage the power to be supplied from, for example, an outlet for the power supply to the above-mentioned devices of the processing terminal 12, or made to manage the residual quantity of the battery.

The memory 21 is a storage unit in the processing unit 12 which permits a data to be read and written at all times, and it includes a RAM (Random-Access Memory) for temporarily storing data or programs when the CPU 18 performs arithmetic operations and a ROM (Read-Only Memory) for storing various kinds of programs and data to be used for the arithmetic operations in the CPU 18.

The system controller 22 is for carrying out the data control between the CPU 18 and the memory 21 or the BIOS 32.

The HDD 23 is a storage unit for storing data, and the HDD controller 24 is for executing the control on the HDD 23.

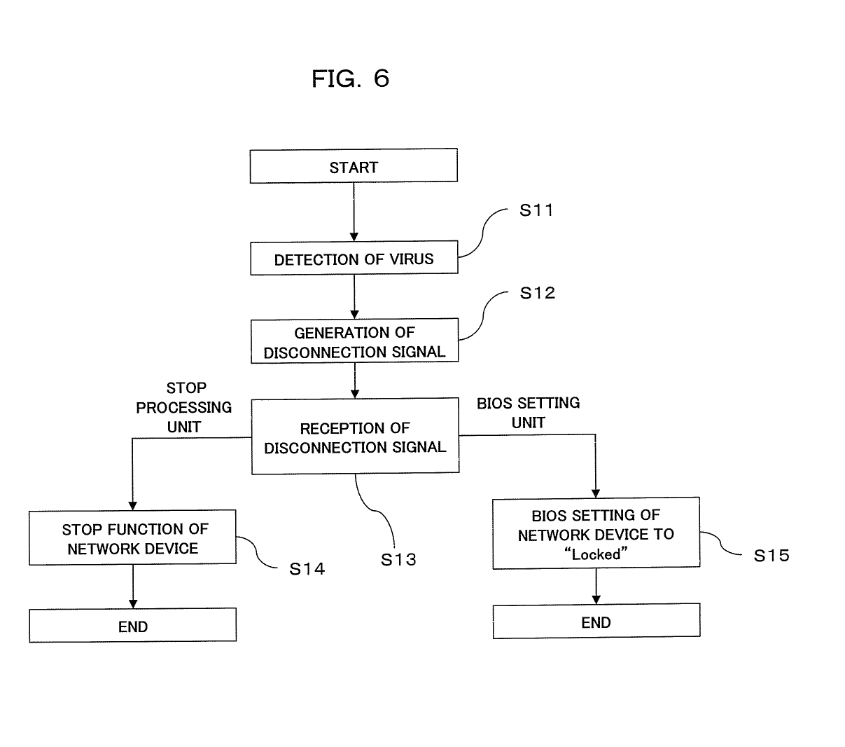

Referring to a flow chart (steps S11 to S15) of FIG. 6, a description will be given hereinbelow of a method for the disconnection from the network 11 in the information processing system 10, configured as described above, according to the first embodiment of the present invention.

First of all, the monitor apparatus 13 detects that the processing terminal 12 has been infected with computer virus or it can be infected therewith (step S11) and generates a disconnection instruction signal d1 giving an instruction for the disconnection of the processing terminal 12 from the network 11 (step S12).

The monitor apparatus 13 transmits the disconnection instruction signal d1, generated by the disconnection signal generating unit 26, to the processing terminal 12, and in this processing terminal 12, the stop processing unit and the BIOS setting unit 34 receive the disconnection instruction signal d1 (step S13).

Upon receipt of the disconnection instruction signal d1, the stop processing unit 33 (see “stop processing unit” route from the step S13) cuts off the power supply to the LAN card 28 to stop the function of the LAN card 28 (step S14; stop processing step), and the processing then comes to an end.

On the other hand, upon receipt of the disconnection instruction signal d1, the BIOS setting unit 34 (see “BIOS setting unit” route from the step S13) places the function of the LAN card 28 into a locked state (Locked) through the BIOS 32 (step S15; BIOS setting step), and the processing then comes to an end.

Thus, the processing terminal 12 falls into a state disconnected from the network 11, thereby preventing the spread of computer virus.

For again connecting the processing terminal 12 to the network 11, there is a need to again boot up (activate) the processing terminal 12 and, in this boot-up process, change the setting of the LAN card 28 for establishing an enabled state (Enabled).

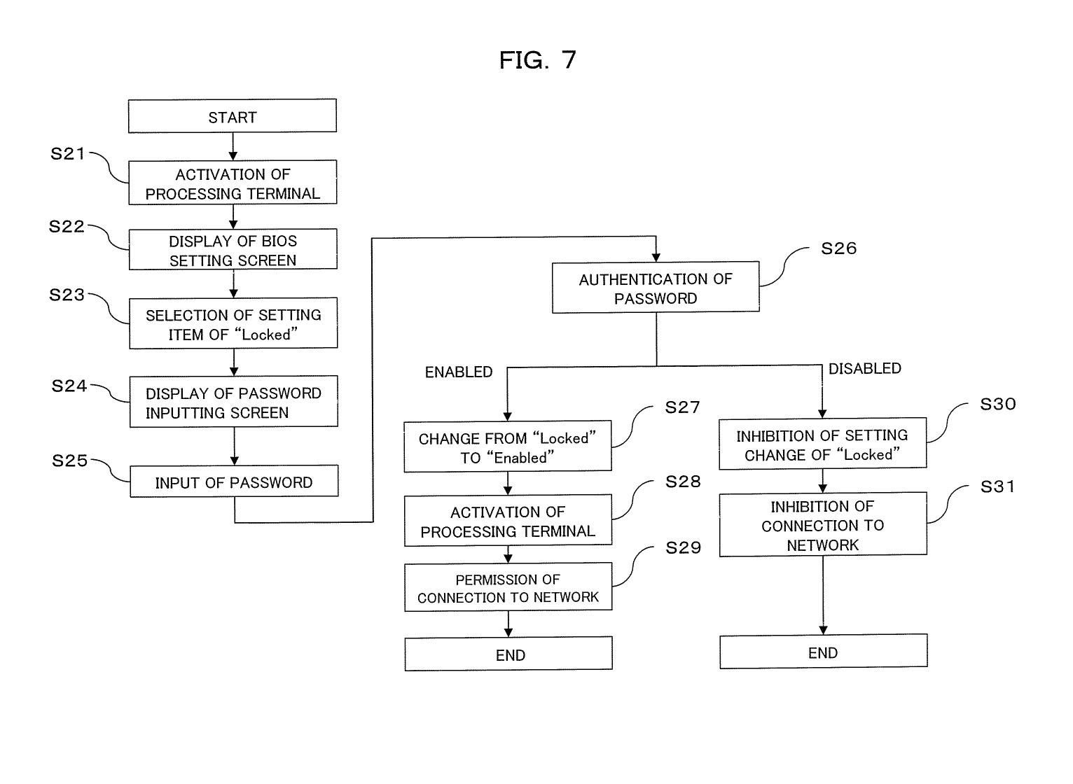

Secondly, referring to a flow chart (steps S21 to S31) of FIG. 7, a description will be given hereinbelow of a method for reconnection to a network in the information processing system 10 according to the first embodiment of the present invention.

First of all, a network supervisor (specified authority person) activates the processing terminal 12 (step S21) and, at this activation, conducts a predetermined operation, for example, pushes an F2 key of the keyboard 30 so as to display the BIOS setting screen, shown in FIG. 4, on the display device 29 (step S22).

When the network supervisor selects, through the keyboard 30 or the like, the setting item 39 corresponding to a device (in the example shown in FIG. 4, the LAN card 28) set as “Locked” on the BIOS setting screen 291 (step S23), the display control unit 16 displays the identification information inputting screen 40 shown in FIG. 5 (step S24; display control step).

When the network supervisor inputs a password to the identification information inputting screen 40 (step S25) and conducts a predetermined operation, for example, pushes an Enter key on the keyboard 30, the CPU 18 starts to authenticate the password (step S26).

The password authentication is made by making a decision as to whether or not the inputted password agrees with a password (registered password; identification information) registered in advance and knowable by only the specified authority person, and when the inputted password agrees with the registered password (see “Enabled” route from step S26), the setting item of the LAN card 28 is changed from “Locked” to “Enabled” (step S27), and the function of the LAN card 28 is changed to an enabled state (Enabled) (release from (cancellation of) disabled state).

When the processing terminal 12 is re-activated in a state where the setting item 39 of the LAN card 28 is set as “Enabled” in the BIOS 32 (step S28), the processing terminal 12 starts in a state connectable to the network (step S29), and the processing comes to an end.

On the other hand, when the inputted password does not agree with the registered password (see “Disabled” route from step S26), the identification information inputting screen 40 is closed without making a change of the setting item of the LAN card 28 from “Locked” (improper setting change from “Locked”; step S30), and the processing returns to the display of the BIOS setting screen shown in FIG. 4.

In this state, since the function of the LAN card 28 is placed into a disabled state (Disabled) by the BIOS 32, the processing terminal 12 starts in a state where the connection to the network 11 is inhibited (step S31), and the processing comes to an end.

Thus, with the information processing system 10 according to the first embodiment of the present invention, on the basis of the disconnection instruction signal d1, the function of the LAN card 28 is stopped, and the function of the LAN card 28 is disabled by the BIOS 32. Accordingly, the reconnection of the processing terminal 12 to the network 11 is inhibited except that, through the POST (Power On Self Test; not shown) processing in the BIOS 32, the setting of the LAN card 28 is once changed into an enabled state (Enabled) by the setup of the BIOS 32.

This inhibits the computer virus from making a release from the disabled state through the BIOS 32, which makes it impossible to make the reconnection of the processing terminal 12 to the network 11.

Therefore, it is possible to reliably prevent the computer virus from spreading through the network 11.

In addition, when the disabled LAN card 28 is set through the BIOS 32 to a locked state (Locked) from which only the specified authority person can make a release (cancellation), even in a case in which a general user having no specified authority tries to make the reconnection to the network 11, it is impossible to change the setting of the BIOS 32.

Thus, for example, not until the specified authority person completes the extermination/quarantine of the computer virus with respect to the processing terminal 12 infected and permits the reconnection to the network, the general user can make the reconnection to the network, which enables the specified authority person to reliably seize the situation of connection to the network. In addition, since the processing terminal 12 which has been infected with computer virus or which can be infected therewith is not connected to the network 11, it is possible to reliably prevent the computer virus from spreading through the network 11.

Therefore, by detecting the computer virus, it is possible to reliably cut off the connection with the network 11 and to reliably maintain the non-connected state with respect to the network 11 after the disconnection, thereby reliably prevent the computer virus from spreading through the network 11.

Moreover, it is possible to completely stop the communication function with respect to the network by cutting off the supply of power to the LAN card 28 or cutting off the supply of a signal to the LAN card 28, and even in a case in which the processing terminal 12 is infected by a computer virus having a function to make a communication freely through self-made reconnection with a network 11, since the processing terminal 12 cannot be connected to the network 11, it is possible to more reliably prevent the spread of the computer virus through the network 11.

Still moreover, since there is a need for the specified authority person to input the identification information through the BIOS setting screen 291 (identification information inputting screen 40) for making a release from the locked state (Locked) set with respect to the LAN card 28, a general user having no special authority cannot freely make a connection of the processing terminal 12 to the network, thereby reliably preventing the spread of the computer virus through the network 11.

### [2] Description of Modification of First Embodiment of the Present Invention

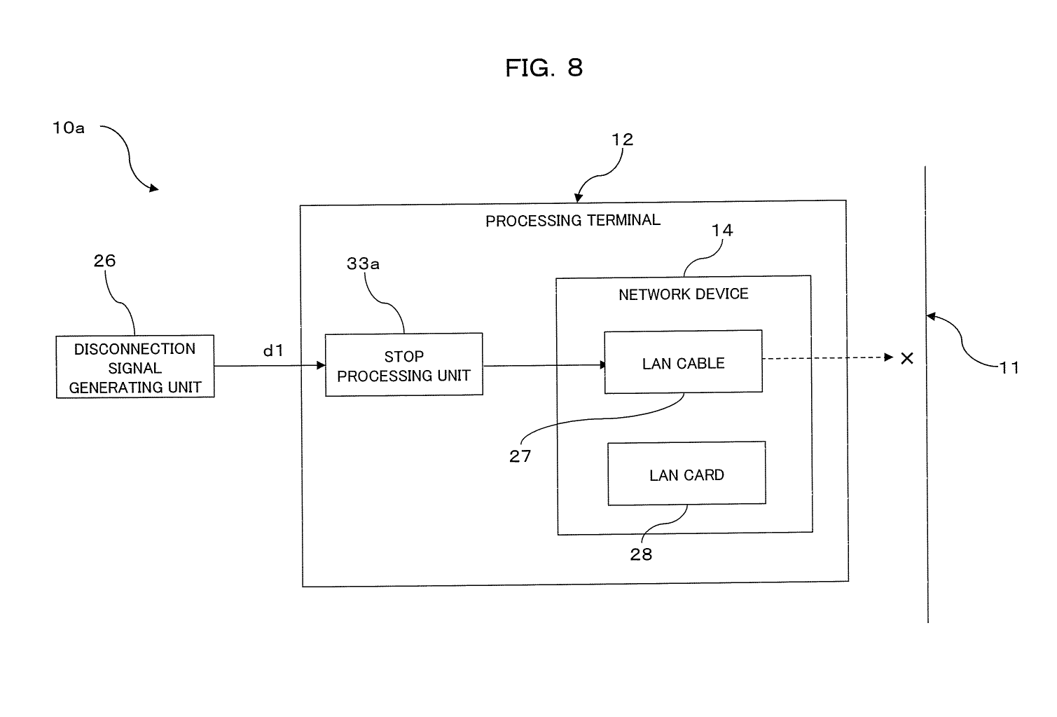

Furthermore, referring to FIGS. 8 to 13, a description will be given hereinbelow of first to third modifications of the information processing system according to the first embodiment of the present invention.

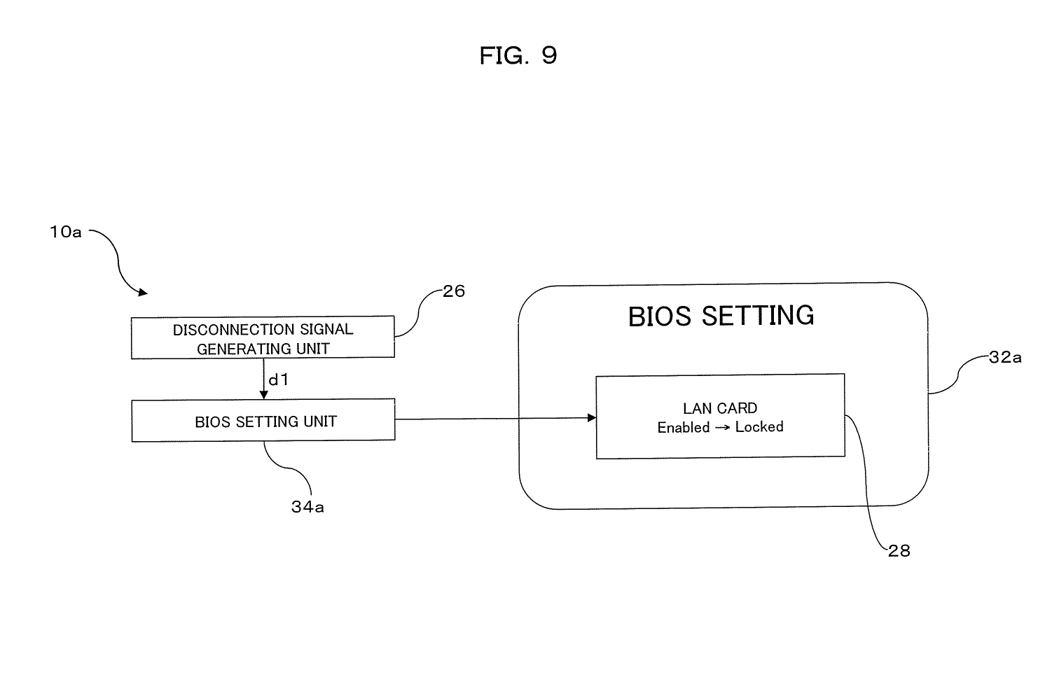

FIG. 8 is an illustration useful for explaining the processing for stopping a function of a device by a stop processing unit in an information processing system according to a first modification of the first embodiment of the present invention, and FIG. 9 is an illustration useful for explaining the processing for disabling a function of a device by a BIOS setting unit therein.

As shown in FIGS. 8 and 9, an information processing system 10a according to a first modification of the first embodiment of the present invention has a stop processing unit 33a and a BIOS setting unit 34a in place of the stop processing unit 33 and the BIOS setting unit 34 in the first embodiment, and the other section is configured as well as that in the information processing system 10 according to the first embodiment.

In the illustrations, the same reference numerals as those used above designate the same or almost same parts, and the detailed description thereof will be omitted for brevity.

As well as the stop processing unit 33 in the above-described first embodiment, the stop processing unit 33a in the first modification is made to stop the function of the network device 14 when receiving a disconnection instruction signal d1, transmitted from the disconnection signal generating unit 26, through the LAN cable 27 and the LAN card 28. In the first modification, as shown in FIG. 8, the LAN cable 27 is disconnected from the network 11 (the LAN cable 27 is physically cut off). Various existing methods are employable as the method of disconnecting the LAN cable 27.

In addition, as well as the BIOS setting unit 34 in the above-described first embodiment, the BIOS setting unit 34a in the first modification is capable of selectively setting the function of the network device 14 in one of an enabled state (Enabled), a disabled state (Disabled) and a locked state (Locked), and in the first modification, as shown in FIG. 9, upon receipt of the disconnection instruction signal d1 sent from the disconnection signal generating unit 26, the function of the LAN card 28 is set in a locked state (Locked).

Thus, with the information processing system 10a according to the first modification of the first embodiment of the present invention, the LAN cable 27 can be disconnected so as to completely stop the communication function with respect to the network 11, even in a case in which the processing terminal 12 is infected by a computer virus having a function to make a communication freely through self-made reconnection with the network 11, the processing terminal 12 cannot be connected to the network 11, it is possible to more reliably prevent the spread of the computer virus through the network 11.

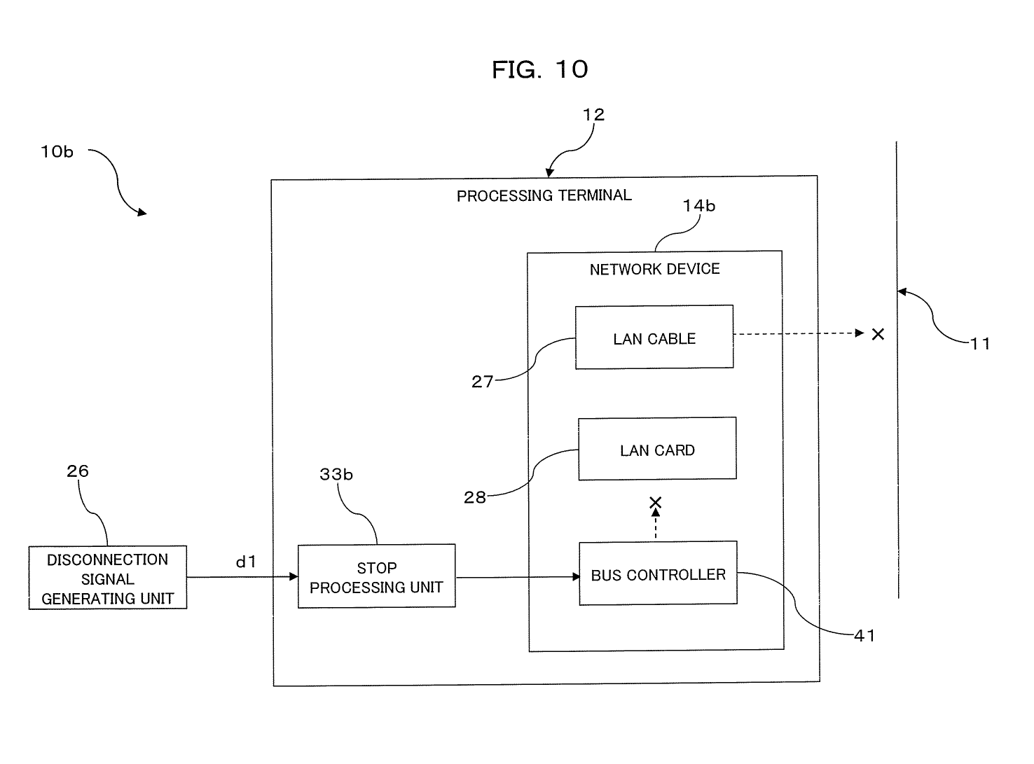

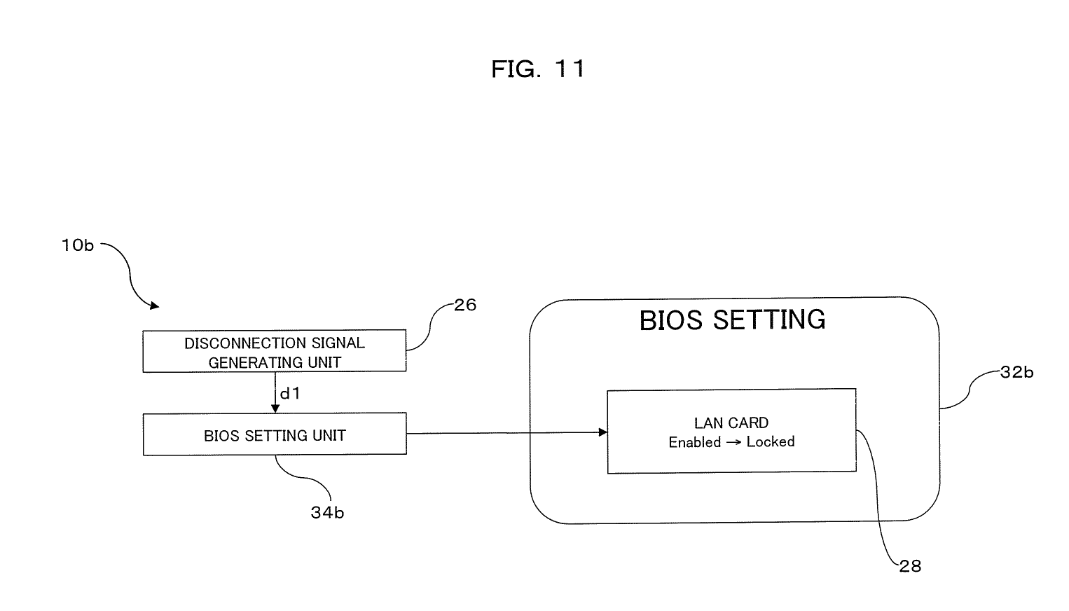

FIG. 10 is an illustration useful for explaining the processing for stopping a function of a device by a stop processing unit in an information processing system according to a second modification of the first embodiment of the present invention, and FIG. 11 is an illustration useful for explaining the processing for disabling a function of a device by a BIOS setting unit in the information processing system according to the second modification of the first embodiment of the present invention.

As shown in FIGS. 10 and 11, an information processing system 10b according to a second modification of the first embodiment of the present invention has a network device 14b, a stop processing unit 33b and a BIOS setting unit 34b in place of the network device 14, the stop processing unit 33 and the BIOS setting unit 34 in the first embodiment, and the other section is configured as well as that in the information processing system 10 according to the first embodiment.

In the illustrations, the same reference numerals as those used above designate the same or almost same parts, and the detailed description thereof will be omitted for brevity.

As well as the network device 14 in the above-described first embodiment, the network device 14b in the second modification has the LAN cable 27 and the LAN card 28 and, as shown in FIG. 10, further has a bus controller 41.

The bus controller 41 is for managing the bus signal access in a bus (wiring) to the LAN card 28 and, as shown in FIG. 10, it is made to be capable of stopping the supply of a bus signal to the LAN card 28 under the control of the stop processing unit 33b.

The stop processing unit 33b in the second modification is made to stop the function of the bus controller 41 upon receipt of a disconnection instruction signal d1 transmitted from the disconnection signal generating unit 26.

Moreover, as well as the BIOS setting unit 34 in the above-described first embodiment, the BIOS setting unit 34b in the second modification is made to be capable of selectively setting the function of the network device 14b in one of an enabled state (Enabled), a disabled state (Disabled) and a locked state (Locked) through the BIOS 32b and, in the second modification, as shown in FIG. 11, the function of the LAN card 28 is set in the locked state (Locked) upon receipt of the disconnection instruction signal d1 transmitted from the disconnection signal generating unit 26.

As described above, the information processing system 10b according to the second modification of the first embodiment of the present invention can completely stop the communication function with respect to the network 11 by cutting of the supply of a signal to the bus controller 41. Accordingly, even in a case in which the processing terminal 12 is infected by a computer virus having a function to make a communication freely through self-made reconnection with a network 11, since the processing terminal 12 cannot be connected to the network 11, it is possible to more reliably prevent the spread of the computer virus through the network 11.

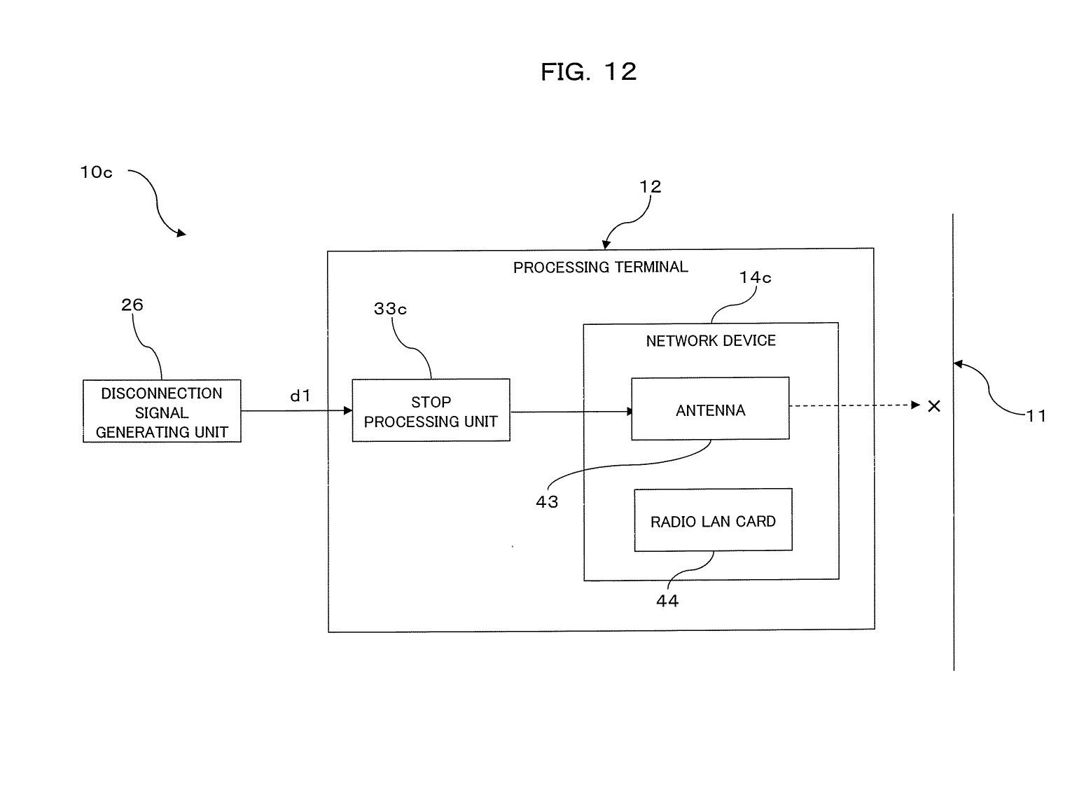

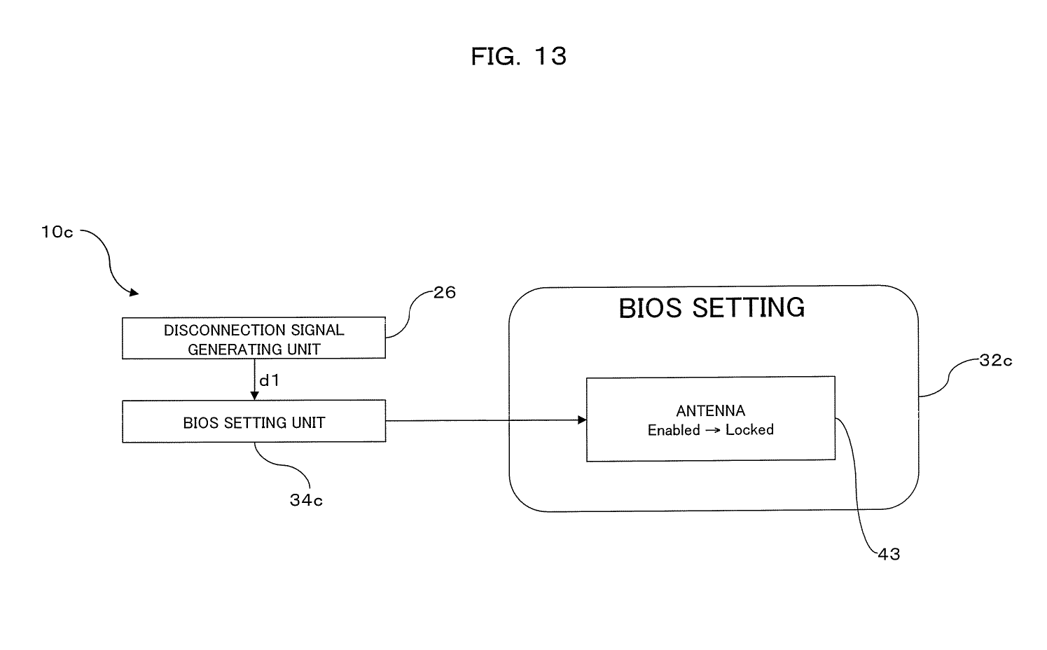

FIG. 12 is an illustration useful for explaining the processing for stopping a function of a device by a stop processing unit in an information processing system according to a third modification of the first embodiment of the present invention, and FIG. 13 is an illustration useful for explaining the processing for disabling a function of a device by a BIOS setting unit therein.

As shown in FIGS. 12 and 13, an information processing system 10c according to a third modification of the first embodiment of the present invention has a network device 14c, a stop processing unit 33c and a BIOS setting unit 34c in place of the network device 14, the stop processing unit 33 and the BIOS setting unit 34 in the first embodiment. The other section is configured as with that in the information processing system 10 according to the first embodiment.

In the illustrations, the same reference numerals as those used above designate the same or almost the same parts, and the detailed description thereof will be omitted for simplicity.

The network device 14c in the third modification is designed to connect the processing terminal 12 to the network by wireless and, as shown in FIG. 12, it is composed of an antenna 43 and a radio LAN card 44.

The antenna 43 is, for example, a high-frequency circuit for making transmission/reception of electric waves with respect to a repeating device, such as a radio router (not shown), installed on the network 11. The radio LAN card 44 has a functional configuration similar to that of the LAN card 28 in the above-described first embodiment, and the description thereof will be omitted for simplicity.

As shown in FIG. 12, when receiving a disconnection instruction signal d1 transmitted from the disconnection signal generating unit 26 through the antenna 43 and the radio LAN card 44, the stop processing unit 33c in the third modification cuts off the supply of power to the antenna 43 for stopping the function of the antenna 43.

Moreover, as with the BIOS setting unit 34 in the above-described first embodiment, the BIOS setting unit 34c in the third modification is made to be capable of selectively set the function of the network device 14c in one of an enabled state (Enabled), a disabled state (Disabled) and a locked state (Locked) through the BIOS 32c. Accordingly, in the third modification, as shown in FIG. 13, the function of the antenna 43 is set in the locked state (Locked) upon receipt of the disconnection instruction signal d1 transmitted from the disconnection signal generating unit 26.

Thus, the information processing system 10c according to the third modification of the first embodiment of the present invention can completely stop the communication function with respect to the network 11 by cutting off the supply of power to the antenna 43. Accordingly, even in a case in which the processing terminal 12 is infected by a computer virus having a function to make a communication freely through self-made reconnection with a network 11, since the processing terminal 12 cannot be connected to the network 11, it is possible to more reliably prevent the spread of the computer virus through the network 11.

### [3] Description of Second Embodiment of the Present Invention

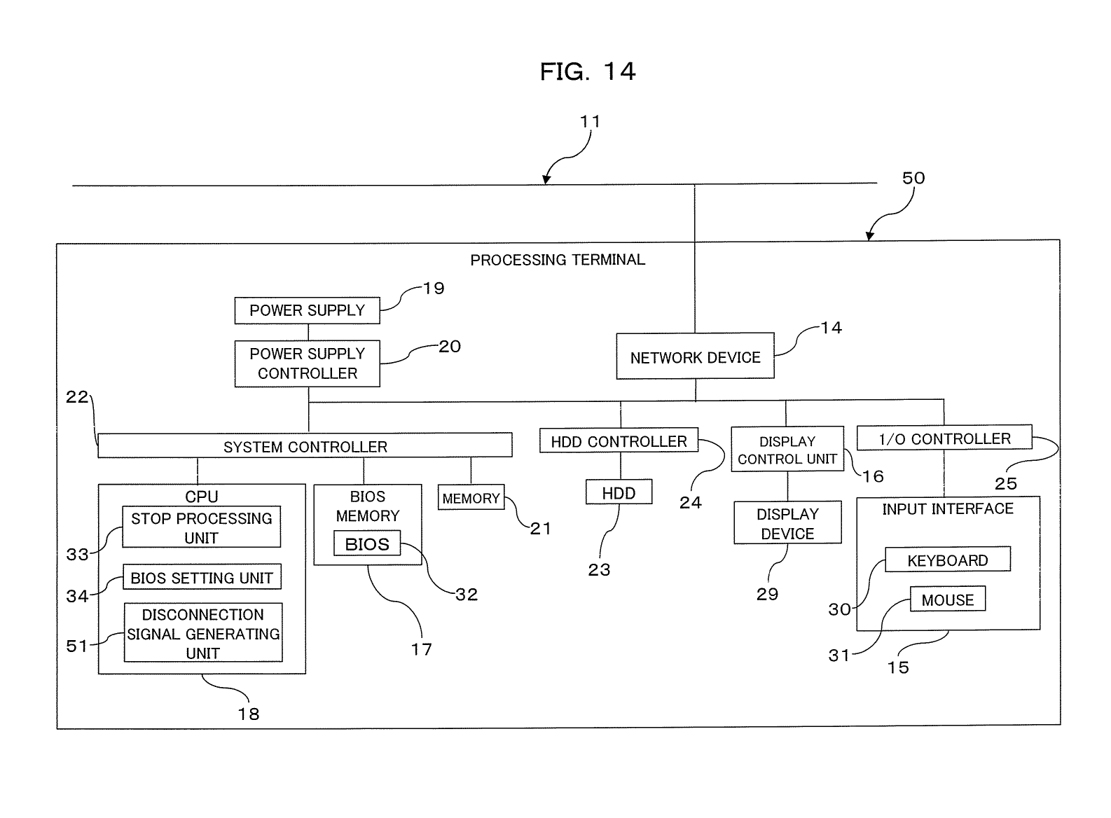

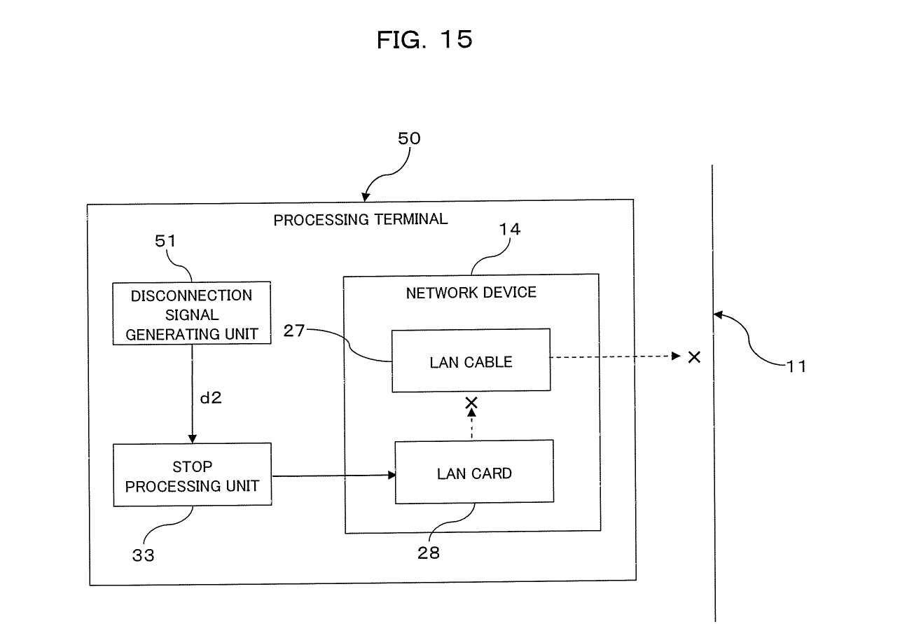

FIG. 14 is a block diagram showing a hardware configuration of an information processing apparatus according to a second embodiment of the present invention, and FIG. 15 is an illustration useful for explaining the processing for stopping a function of a device by a stop processing unit therein.

As shown in FIGS. 14 and 15, in a processing terminal (information processing apparatus) 50 according to the second embodiment of the present invention, a disconnection signal generating unit 51 is provided in the interior of the CPU 18, and the other section is configured as with the processing terminal 12 according to the first embodiment.

In the illustrations, the same reference numerals as those used above designate the same or almost same parts, and the detailed description thereof will be omitted for simplicity.

As well as the disconnection signal generating unit 26 in the information processing system 10 according to the first embodiment, the disconnection signal generating unit 51 in the second embodiment is realized in a manner such that the CPU 18 executes computer virus detection software and, as shown in FIG. 15, when detecting the fact that the processing terminal 50 is infected with a computer virus, it generates and outputs a disconnection instruction signal d2 giving an instruction for the disconnection from the network 11.

In the processing terminal 50, in response to the output of the disconnection instruction signal d2, the stop processing unit 33 stops the function of the LAN card 28, and the BIOS setting unit 34 sets the function of the LAN card 28 in a locked state (Locked).

Thus, since the processing terminal (information processing apparatus) 50 according to the second embodiment of the present invention internally includes the disconnection signal generating unit 51 made to detect a computer virus and further to generate the disconnection instruction signal d2 giving an instruction for the disconnection of the processing terminal 50 from the network 11, even in the case of a computer virus hard to find by an external monitor apparatus, the reliable detection becomes feasible, which can more reliably prevent the computer virus from being spread toward other information processing apparatus on the network 11.

### [4] Others

It should be understood that the present invention is not limited to the above-described embodiments, and that it is intended to cover all changes and modifications of the embodiments of the invention herein which do riot constitute departures from the spirit and scope of the invention.

For example, although in the description of the first embodiment the function of the network device 14 is stopped by cutting off the power supply to the LAN card 28, the present invention is not limited to this, but it is also appropriate that the function of the network device 14 is stopped by inputting a control signal to the LAN card 28.

In addition, a combination of at least two of the above-mentioned method in the first embodiment, the method of physically cutting off the LAN cable 27 in the first modification and the method of stopping the function of the bus controller 41 in the second modification is also acceptable.

Still additionally, it is also appropriate to, in the third modification, stop the radio LAN card 44 or to stop both the radio LAN card 44 and the antenna 43.

Moreover, although in the above description of the embodiments a change of setting of the BIOS 32 from the OS is impossible, the present invention is not limited to this, but it is also acceptable that the change of setting of the BIOS 32 can be made from the OS.

Still moreover, the identification information can be biometrics information such as fingerprint other than password and, in this case, the identification information is registered by a specified authority person after purchase instead of at the factory shipment.

Yet moreover, it is desirable that a request for the input of the biometrics information is made through the BIOS setting screen 291 and the specified authority person inputs it through the use of a fingerprint sensor or the like.

It is also appropriate that the respective functions of the display control unit 16, the disconnection signal generating unit 26, the stop processing unit 33 and the BIOS setting unit 34 in the above-described information processing system are realized in a manner such that a computer (including CPU, information processing apparatus and various types of terminals) executes a predetermined application program (information processing apparatus management program).

This program is offered in a state recorded in a computer-readable recording medium such as flexible disk, CD (including CD-ROM, CD-R, CD-RW) or DVD (including DVD-ROM, DVD-RAM, DVD-R, DVD-RW, DVD+R, DVD+RW). In this case, the computer reads out the information processing apparatus management program from this recording medium, and transfers and stores it in an internal storage unit or an external storage unit. In addition, it is also appropriate that this program is recorded in a storage unit (recording medium) such as magnetic disk, optical disk or magneto optical disk to be offered from the storage unit through a communication line to the computer.

In this case, the computer signifies a concept including hardware and OS (Operating System) and means hardware operated under control of OS. Moreover, in a case in which the OS is unnecessary and an application program operates the hardware by itself, the hardware itself corresponds to the computer. The hardware includes at least a microprocessor such as CPU and a means for reading out a computer program recorded in a recording medium.

The application program serving as the above-described information processing apparatus includes a program code for making the above-mentioned computer realize the functions as the display control unit 16, the disconnection signal generating unit 26, the stop processing unit 33 and the BIOS setting unit 34 in the above-described information processing system 10. Moreover, it is also acceptable that a portion of the functions is realized by the OS instead of the application program.

As the recording medium in this embodiment, in addition to the above-mentioned flexible disk, CD, DVD, magnetic disk, optical disk and magneto optical disk, various types of computer-readable mediums are also available which includes IC card, ROM cartridge, magnetic tape, punch card, internal storage unit (memory such as RAM or ROM) of a computer, external storage unit and further includes printed matter, such as bar code, on which a code is printed.

What is claimed is:

1. An information processing apparatus having a network device and connected through said network device to a network, comprising:
a stop processing unit stopping a function of said network device on the basis of a disconnection instruction signal giving an instruction for disconnection from said network; and
a setting unit disabling said function of said network device on the basis of said disconnection instruction signal and further setting a locked state, releasable only by a specified authority person, with respect to said network device.

2. The information processing apparatus according to claim 1, wherein said stop processing unit stops said function of said network device by cutting off supply of power to said network device.

3. The information processing apparatus according to claim 1, wherein said stop processing unit stops said function of said network device by cutting off supply of a signal to said network device.

4. The information processing apparatus according to claim 1, wherein said stop processing unit stops said function of said network device by inputting a control signal to said network device.

5. The information processing apparatus according to claim 1, further comprising a display control unit displaying a setting screen on a display device for inputting identification information knowable only by said specified authority person so that said specified authority person inputs said identification information through said setting screen to make a release from said locked state set with respect to said network device.

6. A method of managing an information processing apparatus having a network device and connected through said network device to a network, comprising:
a stop processing step stopping a function of said network device on the basis of a disconnection instruction signal giving an instruction for disconnection from said network; and
a setting step disabling said function of said network device on the basis of said disconnection instruction signal and further setting a locked state releasable only by a specified authority person.

7. The method of managing an information processing apparatus according to claim 6, wherein, in said stop processing step, said function of said network device is stopped by cutting off supply of power to said network device.

8. The method of managing an information processing apparatus according to claim 6, wherein, in said stop processing step, said function of said network device is stopped by cutting off supply of a signal to said network device.

9. The method of managing an information processing apparatus according to claim 6, wherein, in said stop processing step, said function of said network device is stopped by inputting a control signal to said network device.

10. The method of managing an information processing apparatus according to claim 6, further comprising a display control step displaying a setting screen on a display device for inputting identification information knowable only by said specified authority person so that said specified authority person inputs said identification information through said setting screen to make a release from said locked state set with respect to said network device.

11. A computer-readable recording medium recording a management program for making a computer carry out a management function to manage an information processing apparatus having a network device and connected through said network device to a network, said management program making said computer function as:
a stop processing unit stopping a function of said network device on the basis of a disconnection instruction signal giving an instruction for disconnection from said network; and
a setting unit disabling said function of said network device on the basis of said disconnection instruction signal and further setting a locked state, releasable only by a specified authority person, with respect to said network device.

12. The computer-readable recording medium recording a management program according to claim 11, wherein, when said management program makes said computer function as said stop processing unit, said management program makes said computer stop said function of said network device by cutting off supply of power to said network device.

13. The computer-readable recording medium recording a management program according to claim 11, wherein, when said management program makes said computer function as said stop processing unit, said management program makes said computer stop said function of said network device by cutting off supply of a signal to said network device.

14. The computer-readable recording medium recording a management program according to claim 11, wherein, when said management program makes said computer function as said stop processing unit, said management program makes said computer stop said function of said network device by inputting a control signal to said network device.

15. The computer-readable recording medium recording a management program according to claim 11, wherein said management program further makes said computer function as a display control unit displaying a setting screen on a display device for inputting identification information knowable only by said specified authority person so that said specified authority person inputs said identification information through said setting screen to make a release from said locked state set with respect to said network device.

16. An information processing system having a network device and connected through said network device to a network, comprising:
a disconnection signal generating unit generating a disconnection instruction signal giving an instruction for disconnection from said network;
a stop processing unit stopping a function of said network device on the basis of said disconnection instruction signal; and
a setting unit disabling said function of said network device on the basis of said disconnection instruction signal and further for setting a locked state, releasable only by a specified authority person, with respect to said network device.

17. The information processing system according to claim 16, wherein said stop processing unit stops said function of said network device by cutting off supply of power to said network device.

18. The information processing system according to claim 16, further comprising a display control unit displaying a setting screen for inputting identification information knowable only by said specified authority person so that said specified authority person inputs said identification information through said setting screen to make a release from said locked state set with respect to said network device.

19. The information processing system according to claim 16, wherein said disconnection signal generating unit generates said disconnection instruction signal when a computer virus is detected by arbitrary detection software.

20. The information processing system according to claim 16, wherein said disconnection signal generating unit is made such that said specified authority person generates said disconnection instruction signal.
